(19) United States
(12) Patent Application Publication
(10) Pub. No.: US 2011/0230381 A1
(43) Pub. Date: Sep. 22, 2011

(54) DETERGENT FOR CLEANING FINS OF COOLING SYSTEM

(76) Inventor: Yin-Chi Chen, Taichung City (TW)

(21) Appl. No.: 12/796,049

(22) Filed: Jun. 8, 2010

(30) Foreign Application Priority Data
Mar. 17, 2010 (TW) 99107900

(51) Int. Cl. C11D 1/825

(52) U.S. Cl. 510/184

(57) ABSTRACT

A detergent for cleaning fins of a condenser/radiator/evaporator has a composition including a surfactant of 0.1%˜55% by weight, an acid substance of 0.1˜50% by weight, and water. The surfactant is made from a halogen or a halide polymerized in an epoxide, and then neutralized with an alkaline substance. The surfactant reacts with the chemical substance of the dirt to remove the dirt from the fins. The acid substance may speed up the reaction. Thus, the detergent of the present invention still may clean the fins in an environment of pH5.0, which is close to the pH value of skin.

### BACKGROUND OF THE INVENTION

1. Field of the Invention

The present invention relates generally to a detergent of surfactant, and more particularly to a detergent with acid anionic compounds to clean fins of a condenser/radiator/evaporator.

2. Description of the Related Art

The condenser/radiator/evaporator of automobiles or motorcycles, or in machine products has fins for heat dissipation. The fins will become dirty after a long time of use, and their color will become dark from metallic luster. The dirt on the fins isolates air from the fins that the heat dissipation of the condenser/radiator/evaporator is reduced.

The dirt on the fins is an accumulation of suspended particles in the air. According to the studies on compositions of suspended particles (Lee, Xu, and Zhou 1992a, 1992b; McMurry and Zhang, 1989; Solomon et al., 1989; Ohta and Okita, 1990; Yoshizumi et al., 1985; Tanner et al., 1979), suspended particles may be classified into water-soluble salts and carbonaceous members, such as oil, dust and metallic elements. It is easy to clean the water-soluble salts and carbonaceous members by common detergent. But the dust and metallic elements and metallic oxides form the fins, after being exposed in the air in a high temperature environment for a long time, are not easy to clean. In the past, it was cleaned by strong acid or strong alkali, such as hydrochloric acid, hydrofluoric acid, sodium hydroxide, and potassium hydroxide. These solutions are corrosive, and no moderate detergent has been found as alternatives.

These corrosive detergents will not just burn people's skin, it will also damage or break the fins during the cleaning process. It may even damage the adjacent devices while washing the fins with detergent of such strong acid or alkali. In practice, when one washes the fins of an automobile with strong acid or alkali, it may splash onto the motor, wires, rubber pads and other devices close to the condenser/radiator/evaporator and cause problems such as short circuit, rusting wires or hardened rubber pads.

Some have tried to dilute or neutralize the detergent to reduce its corrosiveness. However, its pH value has to remain under 2.8, or it will be unable to remove the metallic oxides (such as aluminum oxide), and unable to react to the dust (such as calcium carbonate, magnesium carbonate, and silicon dioxide) and affect the cleaning purpose.

### SUMMARY OF THE INVENTION

The primary objective of the present invention is to provide a detergent for cleaning fins of a condenser/radiator/evaporator, which has a surfactant that will not damage the fins and the surrounding devices, and furthermore, it will not hurt people's skin.

The secondary objective of the present invention is to provide a detergent with a surfactant, which may clean the surfaces of the fin even when the pH value thereof is adjusted to 5.0, which is close to the pH value of human skin.

According to the objectives of the present invention, a detergent composition includes water, a surfactant of 0.1%˜55% by weight, and an acid substance of 0.1˜50% by weight. The surfactant is made from a halogen or a halide polymerized in an epoxide, and then neutralized with an alkaline substance.

The acid substance may speed up the reactions of the surfactant, dirt and metallic oxides on the fins to produce carbon dioxide, water-soluble metallic ions and water. These metallic ions are reduced with halogenate ion in detergent, and the active metallic atom react with water again to form hydroxyl ions, metallic ions and hydrogen, wherein the hydroxyl anions are naturalized with acid substance, and carbon dioxide, hydrogen which are covered by surfactant to form micro bubbles to oscillate the dirt and remove it from the fins.

The detergent of the present invention contains the halogen or halide based surfactant and the acid substance to speed up the reaction that it may clean the fins in a weak acid environment (pH value is between 3.0 and 7.0).

### DETAILED DESCRIPTION OF THE INVENTION

A detergent for cleaning fins of a condenser/radiator/evaporator of a preferred embodiment of the present invention includes compositions of a surfactant, an acid substance, and water. Ratios by weight of these compositions are:

0.1%˜55% of the surfactant;

0.1˜50% of the acid substance;

the rest is water.

A ratio by weight of the detergent of the present invention is 20% of the surfactant, 10% of the acid substance, and 70% of water.

The surfactant is made from a halogen or a halide polymerized in an epoxide, and then neutralized with an alkaline substance.

The halogen and the halogen compound may be selected from fluorine, fluoric acid, fluoride, chlorine, chloric acid, chloride, bromine, bromic acid, bromide, iodine, iodic acid, and iodide, or a combination of any two or more of above.

The epoxide may be selected from ethylene oxide, propylene oxide, or other epoxide with a structure shown in hereunder:

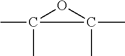

The alkaline substance may be selected from an organic alkaline compound including tetramethylammonium hydroxide, 2-hydroxy-trimethyl ammonium hydroxide, methylamine, dimethylamine, trimethylamine, ethylamine, diethylamine, triethylamine, isopropylamine, diisopropylamine, ethanolamine, diethanolamine and triethanolamine, and an inorganic alkaline compound including lithium hydroxide, sodium hydroxide, potassium hydroxide, ammonium hydroxide, lithium phosphate, lithium dihydrogen phosphate, sodium hydrogen phosphate, sodium dihydrogen phosphate, potassium phosphate, potassium dihydrogen phosphate, ammonium dihydrogen phosphate, lithium silicate, sodium silicate, potassium silicate, lithium metasilicate, sodium metasilicate, potassium metasilicate, lithium carbonate, sodium carbonate, potassium carbonate, sodium hydrogen carbonate, potassium hydrogen carbonate, lithium borate, sodium borate and potassium borate, or a combination of any two or more of above.

In the present invention, the surfactant is made from halogen and phosphorus in a predetermined ratio polymerized in ethylene oxide, and then neutralized with diethanolamine to form the following compound:

Telomer B phosphate diethanolamine salt (1:1:2), CNS No.: 65530-63-4;

Telomer B phosphate diethanolamine salt (2:1:1), CNS No.:65530-64-5;

Telomer B phosphate diethanolamine salt (1:1:1), CNS No.:65530-74-7.

Besides, during the polymerization, phosphorus or phosphide, nitrogen or nitride may be added in polymerization to provide the surfactant with various extents in its reactions.

The acid substance may be selected from an organic acid substance including citric acid, hydroxybutanedioic acid, alpha hydroxy acid, salicylic acid, sulfosalicylic acid, tartaric acid, butanedioic acid, methanoic acid and acetic acid, or an inorganic acid substance including sulfanilic acid, phosphoric acid, nitric acid, boric acid, fluoric acid, chloric acid, chloride and bromic acid, or a combination of any two or more of above.

The acid substance may help the surfactant to quickly react with the dirt and metallic oxides on the fins. In the present invention, the acid substance is citric acid.

The detergent of the present invention may be added with coloring, fragrance, phosphate, and halogen ions to change its look, provide scent, slow down oxidation reaction on the surface of fins, and reduce the metallic ions.

In use of the detergent of the present invention, one may spray it on the fins to have the surfactant react with chemical substances of the dirt on the fins. For example, it reacts with calcium carbonate to form calcium ions and carbon dioxide. The detergent also reacts with metallic oxides to form metallic ions. For example, it reacts with iron oxide, copper oxide, and aluminium oxide to form iron ions, copper ions and aluminum ions, and then these ions are reduced with halogenate ions in detergent, and the active metallic atoms react with water again to form hydroxyl ion, metallic ions and hydrogen, wherein the hydroxyl ions are naturalized with acid substance. The gas is covered by surfactant to form micro bubbles to oscillate the dirt and remove it from the fins.

The citric acid may speed up the reactions of the surfactant and the dirt and metallic oxides on the fins.

After the dirt on the fins is removed by the micro bubbles, it may be washed with water to remove the bubbles and dirt. Thus, the fins are cleaned. The time of cleaning is shortened. For a normal condition, it only takes 2-4 minutes to clean the fin by the detergent of the present invention.

The detergent of the present invention contains the halogen or halide based surfactant and the acid substance to speed up the reaction that it may clean the fins in a weak acid environment (pH value is between 3.0 and 7.0, a normal condition is pH5.0). Accordingly, the detergent of the present invention will not badly hurt skin when people touch it, and furthermore, it will not corrode the surrounding devices either.

The detergent of the present invention provides the halogen or halide based surfactant that will react with the dirt to clean the fins. One only needs to spray the detergent of the present invention on the fins, wait for 2-4 minutes, and then wash the fins with water. No brushing is needed and therefore a possible deformation of the fins can be prevented.

What is claimed is:

1. A detergent composition, comprising:
water;
a surfactant of 0.1%˜55% by weight; and
an acid substance of 0.1˜50% by weight;
wherein the surfactant is made from a halogen or a halide polymerized in an epoxide, and then neutralized with an alkaline substance.

2. The detergent composition as defined in claim 1, wherein the halogen or the halide is selected from the group consisting of fluorine, fluoric acid, fluoride, chlorine, chloric acid, chloride, bromine, bromic acid, bromide, iodine, iodic acid, and iodide.

3. The detergent composition as defined in claim 1, wherein the epoxide is selected from the group consisting of ethylene oxide, propylene oxide, and a compound with a structure of:

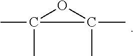

4. The detergent composition as defined in claim 1, wherein the alkaline substance is selected from the group consisting of tetramethylammonium hydroxide, 2-hydroxy-trimethyl ammonium hydroxide, methylamine, dimethylamine, trimethylamine, ethylamine, diethylamine, triethylamine, isopropylamine, diisopropylamine, ethanolamine, diethanolamine, triethanolamine, lithium hydroxide, sodium hydroxide, potassium hydroxide, ammonium hydroxide, lithium phosphate, lithium dihydrogen phosphate, sodium hydrogen phosphate, sodium dihydrogen phosphate, potassium phosphate, potassium dihydrogen phosphate, ammonium dihydrogen phosphate, lithium silicate, sodium silicate, potassium silicate, lithium metasilicate, sodium metasilicate, potassium metasilicate, lithium carbonate, sodium carbonate, potassium carbonate, sodium hydrogen carbonate, potassium hydrogen carbonate, lithium borate, sodium borate, and potassium borate.

5. The detergent composition as defined in claim 1, wherein the acid substance is selected from the group consisting of citric acid, hydroxybutanedioic acid, alpha hydroxy acid, salicylic acid, sulfosalicylic acid, tartaric acid, butanedioic acid, methanoic acid, acetic acid, sulfanilic acid, phosphoric acid, nitric acid, boric acid, fluoric acid, chloric acid, chloride, and bromic acid.

6. The detergent composition as defined in claim 1, wherein the surfactant is made from halogen and phosphorus in a predetermined ratio polymerized in ethylene oxide, and then neutralized diethanolamine to form telomer B phosphate diethanolamine salt (1:1:2), CNS No.: 65530-63-4, telomer B phosphate diethanolamine salt (2:1:1), CNS No.:65530-64-5, and telomer B phosphate diethanolamine salt (1:1:1), CNS No.:65530-74-7.

7. The detergent composition as defined in claim 1, wherein the surfactant is added with phosphorus, phosphide, nitrogen, or nitride when the surfactant is polymerized to change an activity of the surfactant.

8. The detergent composition as defined in claim 1, wherein the acid substance is citric acid.

9. The detergent composition as defined in claim 1, wherein a preferred ratio is 20% by weight of the surfactant, 10% by weight of the acid substance, and 70% by weight of the water.
